(19) United States
(12) Patent Application Publication
(10) Pub. No.: US 2021/0152650 A1
(43) Pub. Date: May 20, 2021

(54) EXTRACTION OF DATA FROM SECURE DATA SOURCES TO A MULTI-TENANT CLOUD SYSTEM

(71) Applicant: Salesforce.com, Inc., San Francisco, CA (US)

(72) Inventor: Ravishankar ARIVAZHAGAN, Union City, CA (US)

(73) Assignee: Salesforce.com, Inc., San Francisco, CA (US)

(21) Appl. No.: 16/778,783

(22) Filed: Jan. 31, 2020

Related U.S. Application Data
(60) Provisional application No. 62/936,970, filed on Nov. 18, 2019.

(51) Int. Cl. H04L 29/08; H04L 12/46; G06F 3/06

(52) U.S. Cl. CPC H04L 67/26; H04L 12/4641; G06F 3/067; G06F 3/0631; G06F 3/0607

(57) ABSTRACT

DESCRIBED HEREIN ARE SYSTEMS, APPARATUS, METHODS AND COMPUTER PROGRAM PRODUCTS FOR AGENT CONTROLLED DATA EXTRACTION FROM SECURE DATA SOURCES TO A MULTI-TENANT CLOUD SYSTEM AN ON-PREMISE AGENT OF A DATA SOURCE MAY RECEIVE COMMUNICATIONS FROM AN OFF-SITE DATA MANAGER. THE AGENT MAY DETERMINE WHETHER TO EXTRACT AND PROVIDE DATA BASED ON THE COMMUNICATIONS. IF THE AGENT EXTRACTS DATA, THE AGENT MAY THEN ACCORDINGLY PUSH DATA OFF-SITE.

### CROSS-REFERENCE TO RELATED APPLICATIONS

This application claims priority to Provisional U.S. Patent Application No. 62/936,970 (Attorney Docket A4653PROV_SFDCP039P) by Arivazhagan, titled “AGENT CONTROLLED DATA EXTRACTION”, filed Nov. 18, 2019, which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the U.S. Patent and Trademark Office patent file or records but otherwise reserves all copyright rights whatsoever

### FIELD OF TECHNOLOGY

This patent document relates generally to data sources and more specifically to data extraction techniques for data sources.

### BACKGROUND

Over the Internet, data may be stored in a variety of different systems. For example data may be stored in cloud systems, virtual private clouds, or on the premises of a user. Connecting to and retrieving data from cloud systems, virtual private clouds, and the user premises presents a variety of control and security challenges.

### BRIEF DESCRIPTION OF THE DRAWINGS

The included drawings are for illustrative purposes and serve only to provide examples of possible structures and operations for the disclosed inventive systems, apparatus, methods and computer program products for agent controlled data extraction from, for example, a user's premises. These drawings in no way limit any changes in form and detail that may be made by one skilled in the art without departing from the spirit and scope of the disclosed implementations.

FIG. 1 illustrates an example configuration of a data system, configured in accordance with one or more embodiments.

FIG. 2 illustrates another example configuration of a data system, configured in accordance with one or more embodiments.

FIGS. 3-5 illustrate examples of portions of a method for extraction of data from secure data sources to a multi-tenant cloud system, performed in accordance with one or more embodiments.

FIGS. 6-8 illustrate dataflow charts showing examples of portions of a method for data from secure data sources to a multi-tenant cloud system, performed in accordance with one or more embodiments.

FIG. 9 shows a block diagram of an example of an environment that includes an on-demand database service configured in accordance with some implementations.

FIGS. 10A and 10B illustrate examples of a computing system, configured in accordance with one or more embodiments.

FIG. 11 illustrates one example of a computing device, configured in accordance with one or more embodiments.

### DETAILED DESCRIPTION

Some implementations of the disclosed systems, apparatus, methods and computer program products are configured for data retrieval from a data source located on a user's premise or on a virtual private cloud (VPC) of the user's (e.g., the database is controlled by the user) to a multi-tenant environment. The data retrieval techniques described herein allow for retrieval in a secure manner while providing flexibility, fine-grained access control, and a single management plane. For the purposes of this disclosure, “database,” “data suite,” and “data source” may be used generally and may refer to any type of data storage technique unless otherwise specified. Thus, for example, each of “database,” “data suite,” and “data source” may refer to traditional server based databases, but may also refer to multiple databases connected over a cloud network, a folder of a file contained within a harddrive, or another such data storage structure.

Typically, a cloud based data management service connects with an on-premise or VPC data source and requests data from the data source. Such a cloud based data management services may include a cloud data suite that includes a plurality of database elements (e.g., separate servers). Each of such database elements will generally include its own Internet Protocol (IP) address and, indeed, a typical cloud data suite may include hundreds or thousands of database elements with different IP addresses.

Typically, especially for on-premise databases, VPC, or hybrid (e.g., a combination of an on-premise and/or VPC database with one or more other systems) environments, the client data source may include firewalls that are configured to prevent access from unknown or unauthorized IP addresses. When faced with the large number of different IP addresses resulting from the different database elements, the firewall will typically prevent the cloud based data management service from accessing the client data source. In such situations, a user may be required to open their data source for outside access or whitelist a large amount of IP addresses (due to cloud storage) in order to allow the cloud based data management service to access the client data source, compromising security and convenience.

The systems and techniques described herein allows for an agent associated with the client data source to instead function as the gateway to provide and control outbound data from the data source, instead of requiring the client to provide access to the data source to an outside party by whitelisting one or more IP addresses. Thus, while a typical configuration results in the cloud based data management service pulling data from a client data source, the systems and techniques described herein allow for the agent to receive data requests and, in response, push some or all of the data from the client data source to the cloud data suite and/or a data manager associated with the cloud based data management service. Such a configuration increases security and, as there is no need to whitelist large amounts of IP addresses, increases user convenience.

Datadatadata is a cloud based data management service. Datadatadata's cloud data suite includes thousands of database elements, each with its own IP address. Datadatadata is attempting to access WeOnlyStoreSensitiveInformation, LLC's data source in order to import data as part of its data management services. Initially, WeOnlyStoreSensitiveInformation, LLC blocks Datadatadata's access attempt due to large amount of unknown IP addresses of the database elements of Datadatadata. Datadatadata's manager then communicates with WeOnlyStoreSensitiveInformation, LLC's manager to convince them to open their data source by disabling the firewall. Datadatadata then pulls the data from WeOnlyStoreSensitiveInformation, LLC's database. However, while the data source is open due to the firewall being disabled, nefarious actors infiltrate WeOnlyStoreSensitiveInformation, LLC's database and steal stored sensitive information. The resulting liability from the data breach causes WeOnlyStoreSensitiveInformation, LLC to enter bankruptcy and subjects Datadatadata to a large civil suit.

In the techniques described herein, a client device of the user includes an agent. The agent may be disposed, installed, or otherwise in communication with a client data source. The agent may control communication of data from the data source to the Internet (e.g., to the cloud based data management service).

The agent may communicate with a data manager. The data manager may be associated with a cloud based data management service and may temporarily or permanently store data within the cloud. In certain embodiments, the agent may be subscribed to a channel associated with the data manager. The channel may allow for the agent to receive communications and/or data from the data manager. The data manager may be, for example, a server device that may receive data from the user and analyze and/or transform the data. Thus, for example, the data manager may receive data for an analytics service, a web service, a data management service, or another such service. The data manager may provide instructions or proposed instructions (e.g., in the form of an “event”) to the agent. Such instructions may be associated with extraction of data from the database. In certain embodiments, the events may be broadcast on the channel itself and the agent may consume the event and respond accordingly. Thus, the data manager and the agent may not be in direct communication, increasing the security of the database.

The agent may receive the instruction or event and determine, based on the received instruction or event, whether to provide data to the data manager and/or a cloud data suite of the cloud based data management service. If the agent determines that it is appropriate to provide such data, the agent may provide a response to the data manager and proceed to extract the data from the data source. Once the extraction configuration is finalized and scheduled, the extraction may then be performed. The agent may then push the extracted data to the data manager and/or the cloud data suite (e.g., on the same channel or on another channel different from the channel where the event was posted).

In certain embodiments, the data may include both actual data (e.g., data that may be processed or utilized for a specific purpose, such as the contents of the rows and columns of a data spreadsheet) and metadata (e.g., data directed to how the data spreadsheet will be displayed). In such embodiments, the data may be previewed by a user. The metadata may control the display of the actual data in such an embodiment. In such an embodiment the agent may push the actual data to the cloud data suite and may push the metadata to the data manager (e.g., a channel of the data manager). The client may then access the data manager to preview the data. As the metadata controlling the preview is stored on the data manager and, thus, may be quicker to access for the client, the latency for the preview of the data may be reduced.

Following WeOnlyStoreSensitiveInformation, LLC's bankruptcy, Datadatadata switched to requiring agents installed within their client data sources for data extraction. Thus, as part of the onboarding with Datadatadata, clients are required to configure agents within their data sources. The agents are configured to listen for instructions (e.g., requests for data) on a private Datadatadata channel that only Datadatadata can post on. If instructions are received, the client then extracts the data and posts the data on another channel, where clients are allowed to push data to, but are unable to extract data from or otherwise see the contents of the channel. Using such a configuration, clients do not need to disable their firewalls or whitelist hundreds or thousands of IF addresses. The additional security afforded by such a configuration results in Datadatadata's clients not experiencing security breaches during data transfers.

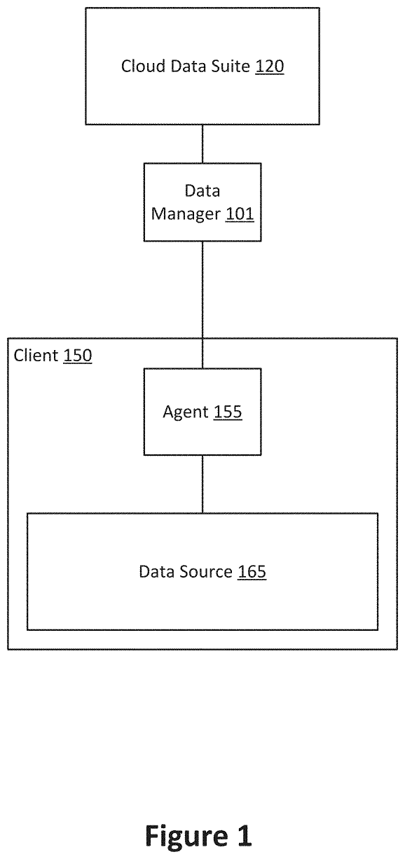

FIG. 1 illustrates an example configuration of a data system, configured in accordance with one or more embodiments. FIG. 1 illustrates a system that includes cloud data suite 120, data manager 101, and client 150. Client 150 includes agent 155 and data source 165. Agent 155 and data source 165 may be associated with the same premise. As described herein, “premise” may denote components that are physically located nearby each other (e.g., within the same facility and/or computer system) and/or may be controlled by the same user (e.g., within a virtual private cloud or other hybrid arrangement or just generally within the control of the user). That is agent 155 and data source 165 may be under the control, operationally or physically, of the same user.

As described herein, data manager 101 may be a data manager that is associated with cloud data suite 120. Cloud data suite 120 may be data storage systems provided by a cloud based data management service and may include one or more database elements. Cloud data suite 120 may be a multi-tenant cloud data system that may be securely communicatively coupled with a plurality of clients at any one time. The systems and techniques described herein allow for secure transfer of data between the cloud based data management service and the plurality of clients, simultaneously or separately, as the transfer with each client is performed in an isolated manner.

Cloud data suite 120 and data manager 101 may be associated with a cloud based data management service (e.g., may be controlled by the cloud based data management service). In various embodiments, data manager 101 may allow for additional devices or services (e.g., analytics systems) to access data from cloud data suite 120, provide data to the additional devices or services, and/or control data flow into cloud data suite 120. Data manager 101 may also additionally organize data within cloud data suite 120.

Agent 155 may be configured to push data obtained from data source 165 to external devices, such as data manager 101 and/or cloud data suite 120. In various embodiments, agent 155 may be downloaded to or otherwise configured on a device associated with client 150 (e.g., client 150 may include a computing device and agent 155 may be downloaded to the computing device of client 150). Access to data source 165 may be granted and/or otherwise controlled by agent 155.

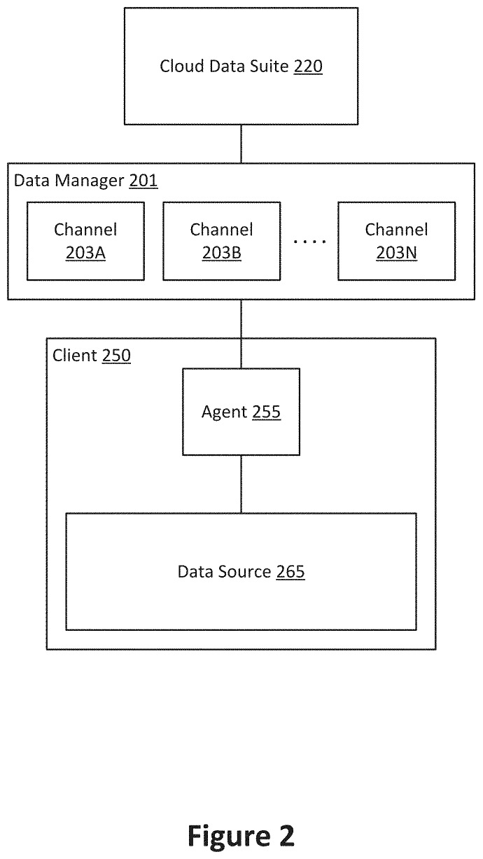

Agent 155 and data manager 101 may communicate through one or more wired and/or wireless connections. Communications between agent 155 and data manager 101 (e.g., requests for data, pushing of data from agent 155 to data manager 101, and other such communications) may be through such connections. An embodiment of how agent 155 and data manager 101 communicates may be further illustrated in FIG. 2.

FIG. 2 illustrates another example configuration of a data system, configured in accordance with one or more embodiments. FIG. 2 includes client 250, cloud data suite 220, and data manager 201. Client 250 includes agent 255 and data source 265. Agent 255 and data source 265 may be similar to that of agent 155 and data source 165 of FIG. 1. Cloud data suite 220 may be similar to that of cloud data suite 120 of FIG. 1.

Data manager 201 may include a plurality of platform event channels 203A-N. In various embodiments, agent 255 and data manager 201 may communicate via one or more of platform event channels 203A-N. In such an embodiment, data manager 201 may publish events on a first platform event channel, such as channel 203A. The event may include a request for data from data source 265, an agent ID (e.g., to identify the client that it is address toward), and a reply ID to identify the event and a location where various portions of the requested data may be posted (e.g., channel 203B and/or cloud data suite 220). In certain embodiments, events are durable and may persist for a period of time (e.g., a set period of time). In various embodiments, channel 203A is configured to only allow posting from data manager 201, cloud data suite 220, and/or the associated cloud based data management service. In such an embodiment, channel 203A may be visible to one or more clients (e.g., client 250). The one or more clients may receive (e.g., download) the events from channel 203A, but may not be allowed to post on channel 203A. As such, only the cloud based data management service may post events.

In various embodiments, different clients may be provided with one or more channels that are limited to communications between the cloud based data management service and the specific client. In other embodiments, a plurality of clients may be able to consume events from and/or provide data to one channel.

Agent 255 may be configured to periodically or continuously check channel 203A to determine if any events are addressed to agent 255. Upon detecting the event, agent 255 may then consume (e.g., download or otherwise access any data within the event and erase the event) the event and publish a response to the event on a different server-only accessible channel (e.g., channel 203B) that is accessible by data manager 201, cloud data suite 220, and/or the associated cloud based data management service. In certain embodiments, channel 203B may be configured such that agent 255 may be allowed to push data onto channel 203B, but the agents of various clients (including or excluding client 250) may not be allowed to pull, download, and/or otherwise view data posted on channel 203B. Such a configuration allows for replies by agent 255 to only be visible to data manager 201. Upon receiving the response, data manager 201 may then consume the response (e.g., by downloading the data). In various embodiments, channel 203B may be configured to receive only a portion of (e.g., the metadata) or all of the data requested.

As such, instead of data manager 201 reaching out to data source 265 to obtain data by pulling data from data source 265, in the configuration of FIGS. 1 and 2, agent 255 now responds to requests through events posted by data manager 201. Accordingly, in such an embodiment, data connections from data source 265 are outbound and controlled by agent 255. Agent 255 and, accordingly, client 250 may, thus, sever any data connections with data manager 201 or otherwise restrict access as needed (e.g., for the security of client 250).

In certain embodiments, though agent 255 controls the flow of data from data source 265, data manager 201 schedules and controls when data extraction from data source 265 happens. Thus, though the data connection is configured on-premises by agent 255, details of the extraction itself may be controlled by data manager 201 (e.g., by the cloud based data management service). As such, client 250 in such embodiments may not be required to log into any account or provide any credentials as data extraction from data source 265 is scheduled on the cloud.

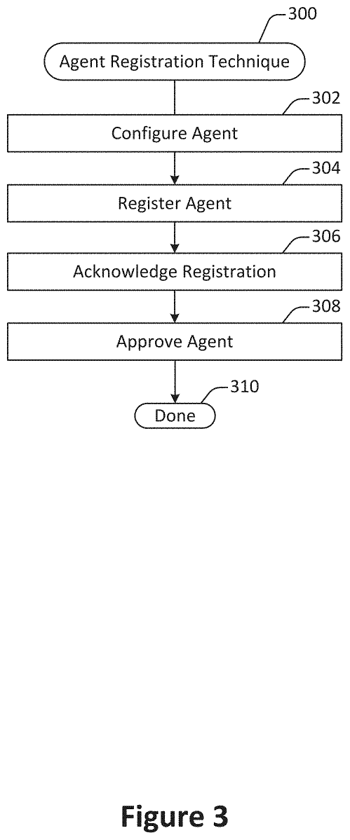

FIGS. 3-5 illustrate examples of portions of a method for extraction of data from secure data sources to a multi-tenant cloud system, performed in accordance with one or more embodiments.

FIG. 3 illustrates an agent registration technique 300. In block 302, the agent is configured. Configuring the agent includes, for example, installing the agent on a computing system, configuring any log-in credentials, and/or any other needed blocks to set up the agent. In certain embodiments, the agent may be constructed from or may include custom application programming interface (API) constructed by the client or a third party. Thus, clients may have control over how their agents are configured and/or provide custom capabilities to their agents. The agents may also additionally be a standard agent provided by the cloud based data management service.

In block 304, upon configuring the agent, the agent attempts to register with the data manager and/or a service associated with the data manager. The agent may attempt to register by, for example, publishing a message to a channel of the data manager to provide an indication that the agent is configured. The data manager may receive the message and acknowledge the registration in block 306. The data manager may additionally authenticate and approve the agent in block 308. The authentication process may include, for example, the agent providing various requested authentication data to the data manager. After approval, the agent may then communicate with the data manager via a platform (e.g., one or more channels described herein).

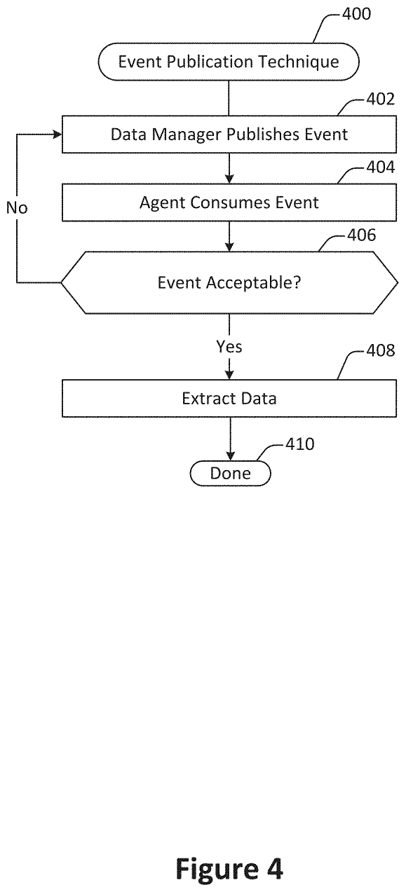

FIG. 4 illustrates an event publication technique 400. Event publication technique 400 is directed to communication of events between the data manager and the agent to, for example, request data from the agent. In block 402, the data manager may publish an event to a first channel. The first channel may be configured to allow for the data manager to publish events (e.g., requests for data) that are to be consumed by various agents of clients.

The agent consumes the event in block 404. The event may be, for example, a request for data from the agent and/or a database associated (e.g., controlled) by the agent. The agent may determine if the request is acceptable or not in block 406. Thus, for example, the agent may determine whether the cloud based data management service is permitted to receive the data at that time in block 406.

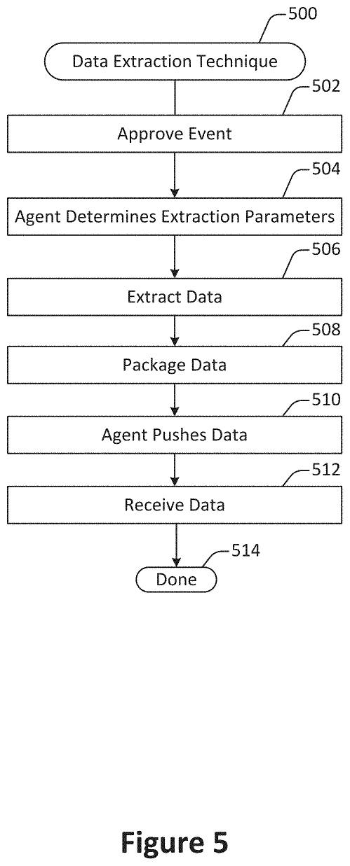

If the agent determines that the request is not acceptable, the technique may return to block 402. If the event is acceptable, the technique may proceed to block 408 and the requested data may be extracted. The extraction of data is further detailed in FIG. 5.

FIG. 5 illustrates a data extraction technique 500. In block 502, the agent approves of the event posted to the first channel. The event may include a request for data and may additionally specify where portions of the data should be provided to. After approving of the event, the agent determines the data extraction parameters in block 504. The data may be extracted from, for example, an on-premise database, VPC, or hybrid data source. Such parameters for extraction may include, for example, converting data to a specific format or staging and/or pushing the data towards a specific location. Additional details as to the extraction of data from a client database may be detailed in U.S. patent application Ser. No. 15/358,128, filed Nov. 21, 2016, and entitled “Streamlined Creation and Updating of OLAP Analytic Databases,” which is hereby incorporated by reference in its entirety for all purposes.

The agent then extracts the data based on the parameters in block 506 and packages the extracted data (e.g., creates a dataset and creates metadata, as appropriate) in block 508. The extracted data and/or datasheet is pushed to the location(s) requested in block 510. The location may be, for example, a second channel of the data manager specifically configured for agents to push data onto and/or a cloud data suite. In certain embodiments, different portions (e.g., the actual data and the metadata) may be pushed to different locations. In other embodiments, all data may be pushed to the same location. In certain such embodiments, the data may thus bypass the channels entirely and be directly uploaded to the cloud data suite by the agent.

When data is pushed to the second channel, the second channel may be configured such that no agents of any clients are able to access data pushed onto the second channel. In various embodiments, the various agents and/or various clients may be assigned their own specific second channel, to further provide data security. The data manager and/or cloud data suite then receives the data in block 512 and the technique is finished in block 514.

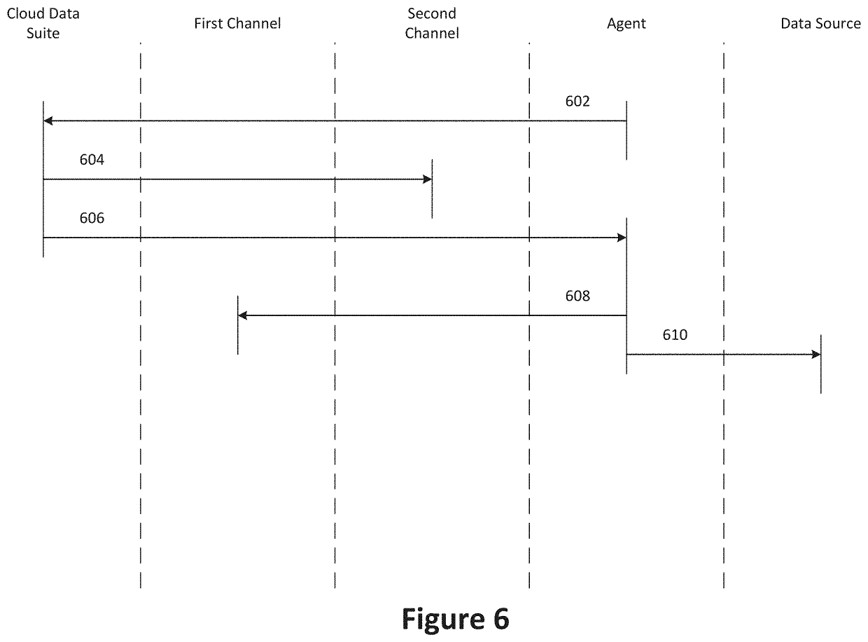

FIGS. 6-8 illustrate dataflow charts showing examples of portions of a method for data from secure data sources to a multi-tenant cloud system, performed in accordance with one or more embodiments. FIGS. 6-8 illustrate techniques that include a cloud data suite, first and second channels, an agent associated with an on-premise or VPC database, and a data source.

FIG. 6 illustrates dataflow for a configuration and registration technique for an agent of a client. The agent may be installed upon the client computing device and, after installation, may communicate log-in data 602 to the cloud data suite. Log-in data 602 may include information that may register the agent with the cloud data suite. The cloud data suite may provide feedback as to the registration (e.g., successful or unsuccessful) in registration response 606. If registration of the agent is successful, the agent may then subscribe 608 to the first channel and, thus, be configured to receive requests from the first channel. Additionally, in embodiments where the agent is configured to push data to channels that are specifically associated with a particular agent, upon registration of the agent with the cloud data suite, the cloud data suite may configure the second channel with configuration data 604. In certain embodiments, the agent may, upon successful registration, additionally communicatively couple with (e.g., configure so that data may be communicated between) the data source to respond to requests.

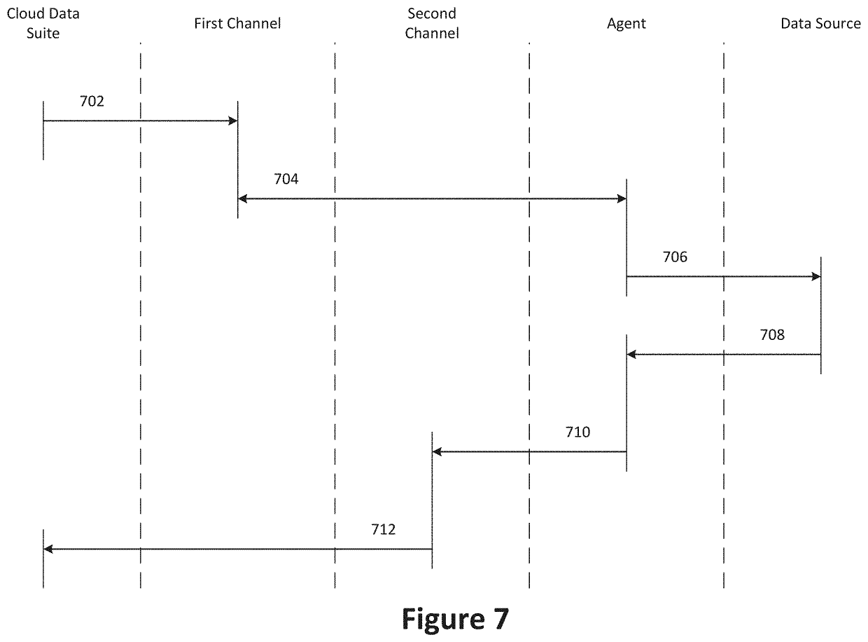

FIG. 7 illustrates dataflow for a command execution technique. In various embodiments, the technique of FIG. 7 may be used to provide commands to the agent. The cloud data suite may post command 702 to the first channel. The agent may receive the command 704 from the first channel and consume the command. The agent may then accordingly execute 706 the command by, for example, checking whether the data source includes certain data. The data source may return a response 708 to the agent and the agent may post a response 710 based on response 708 to the second channel. The cloud data suite may then download 712 the response posted to the second channel.

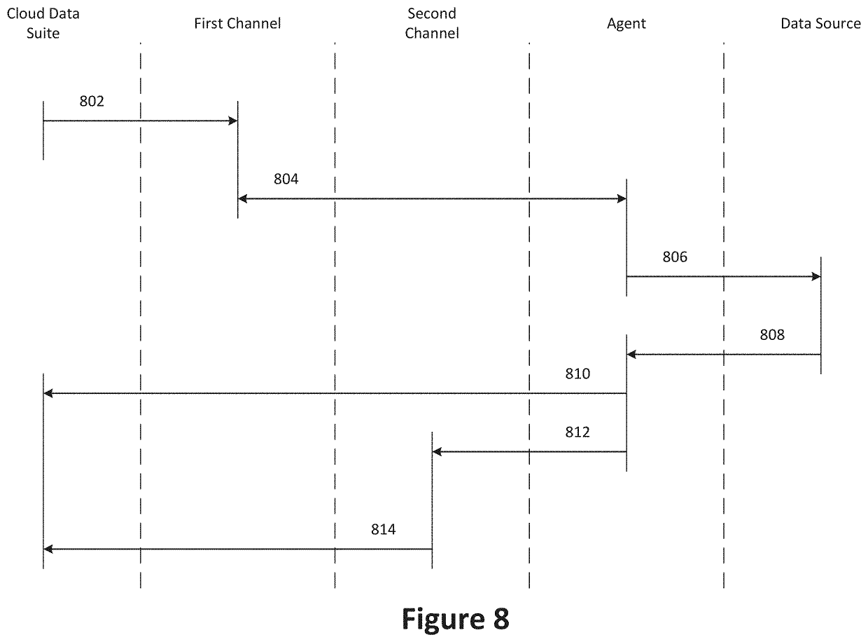

FIG. 8 illustrates dataflow for a data extraction technique. In FIG. 8, the cloud data suite communicates event 802 to the first channel. In certain embodiments, the first channel may be a channel dedicated to allowing for cloud data suite to post requests within the first channel. Event 802 may include a request for data from the data source and may specifically identify the agent and/or the data source as the designated recipient of the event.

The agent then accesses or downloads the event 804 from the first channel and determines that the cloud data suite is authorized to access the data and identifies the data requested. In various embodiments, the agent may consume the event on the first channel and, thus, delete the event from the first channel. The agent may also communicate a request 806 that identifies the data required to the data source to determine if the data requested can be provided (e.g., is stored within the data source) and to extract the data if the data can be provided. Request 806 may also specify how the data is packaged when extracted.

The data source may provide a response 808 that, for example, provides the data in the requested packaged manner. The data source may package the data as appropriate. In various embodiments, the data may include actual data and metadata. In such embodiments, the agent may provide the actual data 810 to the cloud data suite and may provide the metadata 812 to the second channel. In certain embodiments, the second channel may provide the metadata 814 to the cloud data suite, but in other embodiments, the second channel may not provide the metadata to the cloud data suite as the metadata is only directed to previewing the actual data.

In various embodiments, the data of 810 and 812 may include the data requested as well as other data required (e.g., identification data or data identifying the event). In various embodiments, the second channel may be a channel that allows only the cloud data suite to download data from the second channel, as described herein.

The techniques described herein provide for a user interface for users to easily and securely provide data from customer environments (e.g., computing systems on-premise or disposed on a VPC) to a data manager. The techniques described herein allow for an easy to set up and use environment that supports data loading functionality while being secure, resilient, and automated. Based on the needs of the user, the techniques described herein may be scaled accordingly.

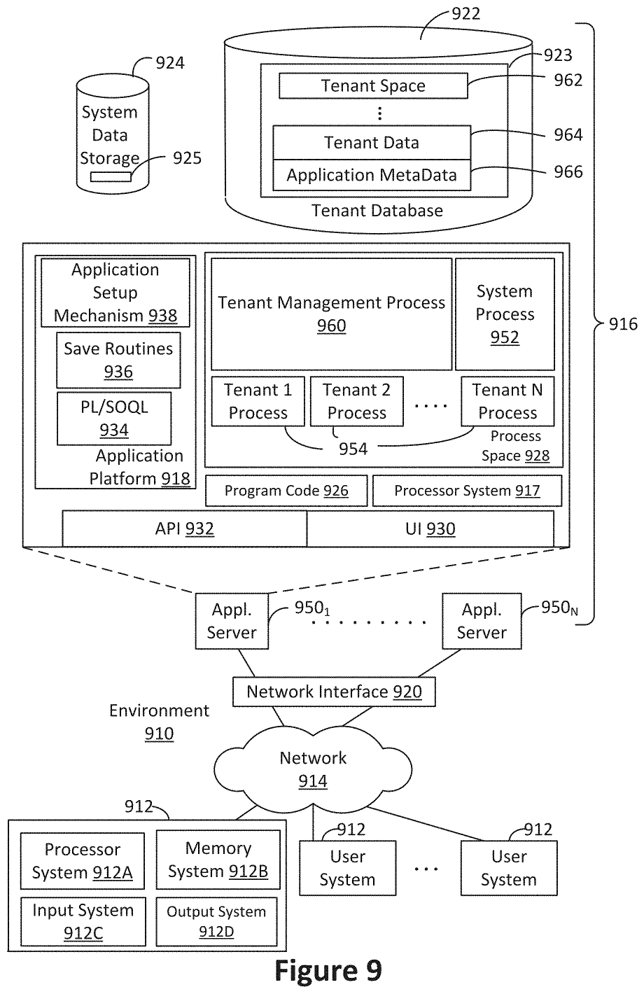

FIG. 9 shows a block diagram of an example of an environment 910 that includes an on-demand database service configured in accordance with some implementations. Environment 910 may include user systems 912, network 914, database system 916, processor system 917, application platform 918, network interface 920, tenant data storage 922, tenant data 923, system data storage 924, system data 925, program code 926, process space 928, User Interface (UI) 930, Application Program Interface (API) 932, PL/SOQL 934, save routines 936, application setup mechanism 938, application servers 950-1 through 950-N, system process space 952, tenant process spaces 954, tenant management process space 960, tenant storage space 962, user storage 964, and application metadata 966. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 916, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 918 may be a framework that allows the creation, management, and execution of applications in system 91.6. Such applications may be developed by the database service provider or by users or third-party application developers accessing the service. Application platform 918 includes an application setup mechanism 938 that supports application developers' creation and management of applications, which may be saved as metadata into tenant data storage 922 by save routines 936 for execution by subscribers as one or more tenant process spaces 954 managed by tenant management process 960 for example. Invocations to such applications may be coded using PL/SOQL 934 that provides a programming language style interface extension to API 932. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 966 for a subscriber making such an invocation. Such system processes may also manage execution of application metadata 966 as an application in a virtual machine.

In some implementations, each application server 950 may handle requests for any user associated with any organization. A load balancing function (e.g., an F5 Big-IP load balancer) may distribute requests to the application servers 950 based on an algorithm such as least-connections, round robin, observed response time, etc, Each application server 950 may be configured to communicate with tenant data storage 922 and the tenant data 923 therein, and system data storage 924 and the system data 925 therein to serve requests of user systems 912. The tenant data 923 may be divided into individual tenant storage spaces 962, which can be either a physical arrangement and/or a logical arrangement of data. Within each tenant storage space 962, user storage 964 and application metadata 966 may be similarly allocated for each user. For example, a copy of a user's most recently used (MRU) items might be stored to user storage 964. Similarly, a copy of MRU items for an entire tenant organization may be stored to tenant storage space 962. A UI 930 provides a user interlace and an API 932 provides an application programming interface to system 916 resident processes to users and/or developers at user systems 912.

System 916 may implement a web-based data management system. For example, in some implementations, system 916 may include application servers configured to implement and execute data extraction software applications. The application servers may be configured to provide related data, code, forms, web pages and other information to and from user systems 912. Additionally, the application servers may be configured to store information to, and retrieve information from a database system. Such information may include related data, objects, and/or Webpage content. With a multi-tenant system, data for multiple tenants may be stored in the same physical database object in tenant data storage 922, however, tenant data may be arranged in the storage medium(s) of tenant data storage 922 so that data of one tenant is kept logically separate from that of other tenants. In such a scheme, one tenant may not access another tenant's data, unless such data is expressly shared.

Several elements in the system shown in FIG. 9 include conventional, well-known elements that are explained only briefly here. For example, user system 912 may include processor system 912A, memory system 912B, input system 912C, and output system 912D. A user system 912 may be implemented as any computing device(s) or other data processing apparatus such as a mobile phone, laptop computer, tablet, desktop computer, or network of computing devices. User system 912 may run an Internet browser allowing a user (e.g., a subscriber of an MTS) of user system 912 to access, process and view information, pages and applications available from system 916 over network 914. Network 914 may be any network or combination of networks of devices that communicate with one another, such as any one or any combination of a LAN (local area network), WAN (wide area network), wireless network, or other appropriate configuration.

The users of user systems 912 may differ in their respective capacities, and the capacity of a particular user system 912 to access information may be determined at least in part by “permissions” of the particular user system 912. As discussed herein, permissions generally govern access to computing resources such as data objects, components, and other entities of a computing system, such as a data extraction system, a social networking system, and/or a CRM database system. “Permission sets” generally refer to groups of permissions that may be assigned to users of such a computing environment. For instance, the assignments of users and permission sets may be stored in one or more databases of System 916. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming

Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 916 may provide on-demand database service to user systems 912 using an MTS arrangement. By way of example, one tenant organization may be a company that employs a sales force where each salesperson uses system 916 to manage their sales process. Thus, a user in such an organization may maintain contact data, leads data, customer follow-up data, performance data, goals and progress data, etc., all applicable to that user's personal sales process (e.g., in tenant data storage 922). In this arrangement, a user may manage his or her sales efforts and cycles from a variety of devices, since relevant data and applications to interact with (e.g., access, view, modify, report, transmit, calculate, etc.) such data may be maintained and accessed by any user system 912 having network access.

When implemented in an MTS arrangement, system 916 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 916 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 916 may also maintain system-level data usable by multiple tenants or other data. Such system-level data may include industry reports, news, postings, and the like that are sharable between tenant organizations.

In some implementations, user systems 912 may be client systems communicating with application servers 950 to request and update system-level and tenant-level data from system 916. By way of example, user systems 912 may send one or more queries requesting data of a database maintained in tenant data storage 922 and/or system data storage 924. An application server 950 of system 916 may automatically generate one or more SQL statements (e.g., one or more SQL queries) that are designed to access the requested data. System data storage 924 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

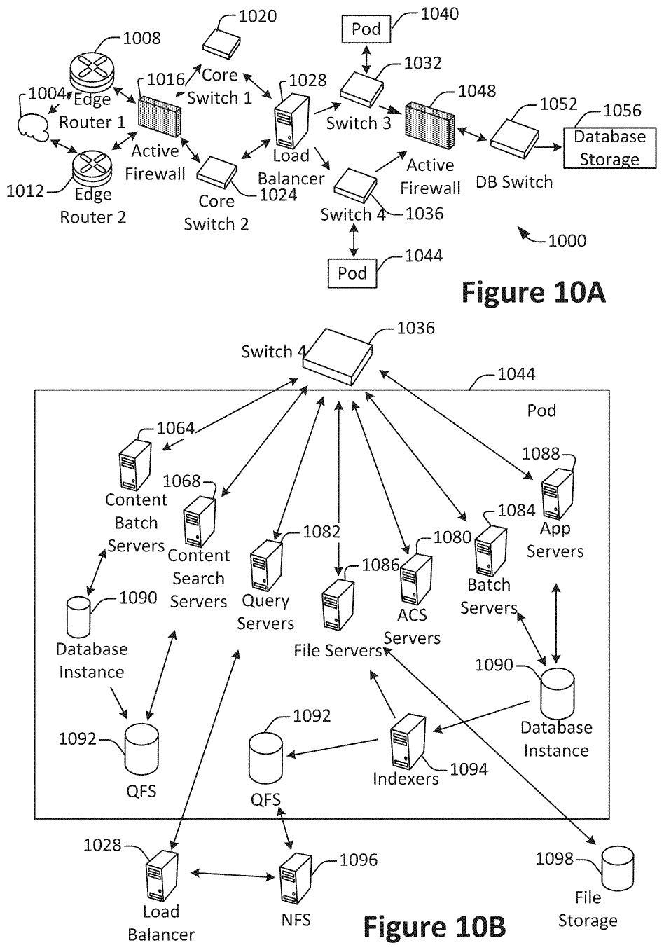

FIGS. 10A and 10B illustrate examples of a computing system, configured in accordance with one or more embodiments. FIG. 10A shows a system diagram of an example of architectural components of an on-demand database service environment 1000, configured in accordance with some implementations. A client machine located in the cloud 1004 may communicate with the on-demand database service environment via one or more edge routers 1008 and 1012. A client machine may include any of the examples of user systems 912 described above. The edge routers 1008 and 1012 may communicate with one or more core switches 1020 and 1024 via firewall 1016. The core switches may communicate with a load balancer 1028, which may distribute server load over different pods, such as the pods 1040 and 1044 by communication via pod switches 1032 and 1036. The pods 1040 and 1044, which may each include one or more servers and/or other computing resources, may perform data processing and other operations used to provide on-demand services. Components of the environment may communicate with a database storage 1056 via a database firewall 1048 and a database switch 1052.

Accessing an on-demand database service environment may involve communications transmitted among a variety of different components. The environment 1000 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 10A and 10B.

The cloud 1004 refers to any suitable data network or combination of data networks, which may include the Internet. Client machines located in the cloud 1004 may communicate with the on-demand database service environment 1000 to access services provided by the on-demand database service environment 1000. By way of example, client machines may access the on-demand database service environment 1000 to retrieve, store, edit, and/or process data.

In some implementations, the edge routers 1008 and 1012 route packets between the cloud 1004 and other components of the on-demand database service environment 1000. The edge routers 1008 and 1012 may employ the Border Gateway Protocol (BGP). The edge routers 1008 and 1012 may maintain a table of IP networks or ‘prefixes’, which designate network reachability among autonomous systems on the internet.

In one or more implementations, the firewall 1016 may protect the inner components of the environment 1000 from Internet traffic. The firewall 1016 may block, permit, or deny access to the inner components of the on-demand database service environment 1000 based upon a set of rules and/or other criteria. The firewall 1016 may act as one or more of a packet filter, an application gateway, a stateful filter, a proxy server, or any other type of firewall.

In some implementations, the core switches 1020 and 1024 may be high-capacity switches that transfer packets within the environment 1000. The core switches 1020 and 1024 may be configured as network bridges that quickly route data between different components within the on-demand database service environment. The use of two or more core switches 1020 and 1024 may provide redundancy and/or reduced latency.

In some implementations, communication between the pods 1040 and 1044 may be conducted via the pod switches 1032 and 1036. The pod switches 1032 and 1036 may facilitate communication between the pods 1040 and 1044 and client machines, for example via core switches 1020 and 1024. Also or alternatively, the pod switches :1032 and 1036 may facilitate communication between the pods 1040 and 1044 and the database storage 1056. The load balancer 1028 may distribute workload between the pods, which may assist in improving the use of resources, increasing throughput, reducing response times, and/or reducing overhead. The load balancer 1028 may include multilayer switches to analyze and forward traffic.

In some implementations, access to the database storage 1056 may be guarded by a database firewall 1048, which may act as a computer application firewall operating at the database application layer of a protocol stack. The database firewall 1048 may protect the database storage 1056 from application attacks such as structure query language (SQL) injection, database rootkits, and unauthorized information disclosure. The database firewall 1048 may include a host using one or more forms of reverse proxy services to proxy traffic before passing it to a gateway router and/or may inspect the contents of database traffic and block certain content or database requests. The database firewall 1048 may work on the SQL application level atop the TCP/IP stack, managing applications' connection to the database or SQL management interfaces as well as intercepting and enforcing packets traveling to or from a database network or application interface.

In some implementations, the database storage 1056 may be an on-demand database system shared by many different organizations. The on-demand database service may employ a single-tenant approach, a multi-tenant approach, a virtualized approach, or any other type of database approach. Communication with the database storage 1056 may be conducted via the database switch 1052. The database storage 1056 may include various software components for handling database queries. Accordingly, the database switch 1052 may direct database queries transmitted by other components of the environment (e.g., the pods 1040 and 1044) to the correct components within the database storage 1056.

FIG. 10B shows a system diagram further illustrating an example of architectural components of an on-demand database service environment, in accordance with some implementations. The pod 1044 may be used to render services to user(s) of the on-demand database service environment 1000. The pod 1044 may include one or more content batch servers 1064, content search servers 1068, query servers 1082, file servers 1086, access control system (ACS) servers 1080, batch servers 1084, and app servers 1088. Also, the pod 1044 may include database instances 1090, quick file systems (QFS) 1092, and indexers 1094. Some or all communication between the servers in the pod 1044 may be transmitted via the switch 1036.

In some implementations, the app servers 1088 may include a framework dedicated to the execution of procedures (e.g., programs, routines, scripts) for supporting the construction of applications provided by the on-demand database service environment 1000 via the pod 1044. One or more instances of the app server 1088 may be configured to execute all or a portion of the operations of the services described herein.

In some implementations, as discussed above, the pod 1044 may include one or more database instances 1090. A database instance 1090 may be configured as an MTS in which different organizations share access to the same database, using the techniques described above. Database information may be transmitted to the indexer 1094, which may provide an index of information available in the database 1090 to file servers 1086. The QFS 1092 or other suitable filesystem may serve as a rapid-access file system for storing and accessing information available within the pod 1044. The QFS 1092 may support volume management capabilities, allowing many disks to be grouped together into a file system. The QFS 1092 may communicate with the database instances 1090, content search servers 1068 and/or indexers 1094 to identify, retrieve, move, and/or update data stored in the network file systems (NFS) 1096 and/or other storage systems.

In some implementations, one or more query servers 1082 may communicate with the NFS 1096 to retrieve and/or update information stored outside of the pod 1044. The NFS 1096 may allow servers located in the pod 1044 to access information over a network in a manner similar to how local storage is accessed. Queries from the query servers 1022 may be transmitted to the NFS 1096 via the load balancer 1028, which may distribute resource requests over various resources available in the on-demand database service environment 1000. The NFS 1096 may also communicate with the QFS 1092 to update the information stored on the NFS 1096 and/or to provide information to the QFS 1092 for use by servers located within the pod 1044.

In some implementations, the content batch servers 1064 may handle requests internal to the pod 1044. These requests may be long-running and/or not tied to a particular customer, such as requests related to log mining, cleanup work, and maintenance tasks. The content search servers 1068 may provide query and indexer functions such as functions allowing users to search through content stored in the on-demand database service environment 1000. The file servers 1086 may manage requests for information stored in the file storage 1098, which may store information such as documents, images, basic large objects (BLOBs), etc. The query servers 1082 may be used to retrieve information from one or more file systems. For example, the query system 1082 may receive requests for information from the app servers 1088 and then transmit information queries to the NFS 1096 located outside the pod 1044. The ACS servers 1080 may control access to data, hardware resources, or software resources called upon to render services provided by the pod 1044. The batch servers 1084 may process batch jobs, which are used to run tasks at specified times. Thus, the batch servers 1084 may transmit instructions to other servers, such as the app servers 1088, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

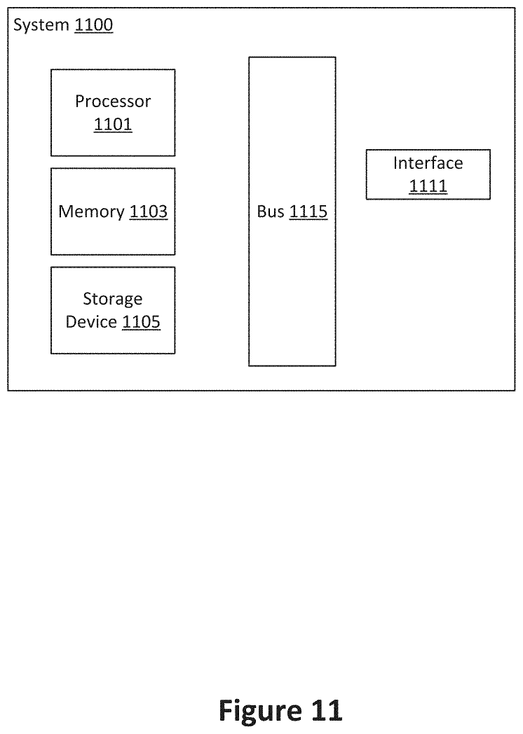

FIG. 11 illustrates one example of a computing device. According to various embodiments, a system 1100 suitable for implementing embodiments described herein includes a processor 1101, a memory module 1103, a storage device 1105, an interface 1111, and a bus 1115 (e.g., a PCI bus or other interconnection fabric.) System 1100 may operate as variety of devices such as an application server, a database server, or any other device or service described herein. Although a particular configuration is described, a variety of alternative configurations are possible. The processor 1101 may perform operations such as those described herein. Instructions for performing such operations may be embodied in the memory 1103, on one or more non-transitory computer readable media, or on some other storage device. Various specially configured devices can also be used in place of or in addition to the processor 1101. The interface 1111 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices, A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
receiving, with an agent associated with an on-premise and/or virtual private cloud (VPC) data source, an event;
determining that the event is associated with extraction of requested data from the on-premise and/or UPC data source;
extracting, with the agent, the requested data from the on-premise and/or VPC data source; and
pushing, with the agent, the requested data to a cloud based data management service.

2. The method of claim 1, wherein the requested data comprises actual data and metadata.

3. The method of claim 2, wherein the pushing the requested data comprises:
pushing the actual data to a cloud data suite associated with the cloud based data management service; and
pushing the metadata to a data manager associated with the cloud based data management service.

4. The method of claim 3, wherein the cloud data suite comprises a plurality of database elements that each includes a separate Internet Protocol (IP) addresses.

5. The method of claim 2, wherein the receiving the event comprises downloading the event from a first channel of the data manager and deleting the event from the first channel after downloading.

6. The method of claim 2, wherein the metadata is pushed to a second channel of the data manager.

7. A database system implemented using a server system, the database system comprising:
a cloud data suite associated with a cloud based data management service; and
a data manager configured to:
receive an event posted by the cloud based data management service, wherein the event is associated with extraction of requested data from the on-premise and/or VPC data source;
provide the event to an agent of an on-premise and/or virtual private cloud (VPC) database; and
receive first data provided by the agent,

8. The database system of claim 7, wherein the first data is metadata associated with the requested data.

9. The database system of claim 7, wherein the cloud data suite is configured to receive second data provided by the agent.

10. The database system of claim 9, wherein the second data is actual data associated with the requested data.

11. The database system of claim 9, wherein the second data is extracted from the on-premise and/or VPC database by the agent based on the event.

12. The database system of claim 7, wherein data manager comprises a first channel and a second channel, wherein the first channel is configured to receive the event posted by the cloud based data management service and configured to provide the event to the agent, and wherein the second channel is configured to receive the first data.

13. The database system of claim 12, wherein the first channel is configured to exclude the agent from posting on the first channel.

14. The database system of claim 12, wherein the second channel is configured to allow the agent to post the first data and is configured to prevent the agent from accessing any data disposed on the second channel.

15. The database system of claim 12, wherein the first channel is associated with a plurality of different agents, and wherein the second channel is associated with the agent.

16. The database system of claim 7, wherein the cloud data suite is configured to receive the data from the data manager.

17. The database system of claim 7, wherein the cloud data suite comprises a plurality of database elements, each database element associated with a separate Internet Protocol (IP) address.

18. The database system of claim 17, wherein the cloud data suite is configured to receive the data through the plurality of database elements.

19. The database system of claim 7, wherein the cloud data suite is a multi-tenant data suite.

20. A computer program product comprising computer-readable program code capable of being executed by one or more processors when retrieved from a non-transitory computer-readable medium, the program code comprising instructions configurable to cause operations comprising:
receiving, with an agent associated with an on-premise and/or virtual private cloud (VPC) data source, an event;
determining that the event is associated with extraction of requested data from the on-premise and/or VPC data source;
extracting, with the agent, the requested data from the on-premise and/or VPC data source; and
pushing, with the agent, the requested data to a cloud based data management service.
